(19) United States
(12) Patent Application Publication
(10) Pub. No.: US 2012/0274615 A1
(43) Pub. Date: Nov. 1, 2012

(54) ACTIVE MATRIX TYPE MODULE AND DRIVING METHOD OF ACTIVE MATRIX TYPE MODULE

(75) Inventor: Hideo Ochi, Fuchu (JP)

(73) Assignee: PIONEER CORPORATION, Kanagawa (JP)

(21) Appl. No.: 13/509,706

(22) PCT Filed: Nov. 13, 2009
(86) PCT No.: PCT/JP2009/069368

§ 371 Date: May 30, 2012

(51) Int. Cl. G09G 5/00

(52) U.S. Cl. 345/204

(57) ABSTRACT

A data voltage error due to a feed-through effect is corrected without an increase in the number of transistors in capacitive memory cells. A display panel (11) in which a plurality of pixel parts (PL_{j,i}) are arranged at the intersections of scanning lines (Yj) and data lines (Xi) which are arranged in a matrix shape, and each of the pixel parts (PL_{j,i}) includes a scan transistor (21) and a capacitor (24). The display panel supplies a correction pulse (CP), the polarity of which is opposite to that of a scan pulse (SP) to the capacitor (24) of each of the pixel parts (PL_{j,i}) via a signal line (Wj) at approximately the same timing as the timing of the supply of the scan pulse (SP).

### CROSS-REFERENCE TO RELATED APPLICATION

This is an application PCT/JP2009/69368, filed November, 13, which was not published under PCT article 21(2) in English.

### BACKGROUND OF THE INVENTION

1. Field of the Invention

The present invention relates to an active matrix type module wherein a large number of capacitive memory cells comprising built-in active elements made of transistors are disposed at crossing positions of a data line and a scan line disposed in a matrix, and a driving method of the active matrix type module.

2. Description of the Related Art

Active matrix type modules wherein a large number of capacitive memory cells are disposed at crossing positions of a data line and a scan line disposed in a matrix include, for example, a liquid crystal or organic EL (electroluminescent) active matrix type display panel, electronic paper, or memory elements.

For example, a capacitive memory cell of an organic EL panel serving as a single active matrix type module comprises an organic EL element, which is a light emitter, a transistor as an active element, and a capacitive element. The transistor comprises two transistors, a scan transistor and a drive transistor. The gate electrode of the scan transistor is connected to the scan line, and the source electrode is connected to the data line. Further, the source electrode of the drive transistor is connected to a power supply line that supplies consistent power supply voltage, and the gate electrode is connected to the drain electrode of the scan transistor. Furthermore, the capacitive element is connected between the source electrode and the gate electrode of the drive transistor. Then, the anode of the light emitter is connected to the drain of the drive transistor, and the cathode is grounded.

In the above configuration, electricity is conducted between the source and drain electrodes of the scan transistor when a scan pulse is supplied to the gate electrode of the scan transistor from the scan line. With this arrangement, data voltage is supplied from the data line via the source and drain electrodes of the scan transistor, causing an electric charge corresponding to the data voltage to accumulate in the capacitive element. The data voltage accumulated in this capacitive element is supplied between the gate and source electrodes of the drive transistor, and a drain current corresponding to the data voltage is introduced between the drain and source electrodes of the drive transistor and supplied to the organic EL element.

Here, a capacitive parasitic element is generally formed between the gate and source electrodes and gate and drain electrodes of the transistor. This is because, in the transistor, the gate electrode and channel electrode overlap in the layered direction via the gate insulating film, forming capacitance in the overlapping section. While the surface area of the overlapping section tends to decrease as the manufacturing process advances, it is difficult to decrease the overlapping surface area to zero with a coating type semiconductor that uses a printing process, a type that has received much attention in recent years. As a result, when a scan pulse is supplied to the drive transistor with the parasitic element formed, the charge accumulated in the capacitive element is extracted by a feed-through effect during the pulse OFF moment, resulting in the problem of errors in the data voltage.

In prior art, techniques have been proposed wherein a correction transistor that is half the size of the drive transistor is utilized to offset the reduction in the charge caused by feed-through as a countermeasure to prevent such feed-through (see “Development of Zero-drift Amplifier,” Kosuke Fujimoto and one other, Omron Technics, Omron Corp., 2004, Vol. 44, No. 1 (Consecutive Vol. 149), p. 71-74, for example).

### SUMMARY OF THE INVENTION

### Problem to be Solved by the Invention

According to the above prior art, a correction transistor needs to be added to all capacitive memory cells of the active matrix type module. As a result, the problem arises that a decrease in the yield of the active matrix type module may result from the complex structure, and a decrease in the aperture ratio may result from the increase in the number of transistors.

The above-described problem is given as an example of the problems that are to be solved by the present invention.

### Means for Solving the Problems

In order to achieve the above-mentioned object, according to the invention of Claim 1, there is provided an active matrix type module comprising: a large number of capacitive memory cells disposed at crossing positions of a scan line and a data line disposed in a matrix, the capacitive memory cell including: a first transistor that has a gate electrode connected to the scan line, and a source electrode connected to the data line; and a capacitive element that, when a first terminal on one side is connected to a drain electrode of the first transistor and a scan pulse is supplied to the gate electrode from the scan line, accumulates a charge corresponding to a data voltage supplied from the data line via the source electrode and the drain electrode; and a capacitive element that has a first terminal on one side connected to a drain electrode of the first transistor and that, when a scan pulse is supplied to the gate electrode from the scan line, accumulates a charge corresponding to a data voltage supplied from the data line via the source electrode and the drain electrode; and wherein the active matrix type module further comprises a reverse polarity pulse supplying portion that supplies a reverse polarity pulse, which has reverse polarity to the scan pulse and is generated by logically inverting a phase of the scan pulse, to the capacitive element via ₖsecond terminal of the other side of the capacitive element based on a timing that ensures simultaneity with an ON/OFF timing of the scan pulse.

In order to achieve the above-mentioned object, according to the invention of Claim 5, there is provided an active matrix type module comprising: a large number of capacitive memory cells disposed at crossing positions of a scan line and a data line disposed in a matrix, the capacitive memory cell including: a first transistor that has a gate electrode connected to the scan line, and a source electrode connected to the data line; a capacitive element that has a first terminal on one side connected to a drain electrode of the first transistor and that, when a scan pulse is supplied to the gate electrode from the scan line, accumulates a charge corresponding to a data voltage supplied from the data line via the source electrode and the drain electrode; and a second transistor that has a gate electrode connected to a drain electrode of the first transistor and the first terminal of the capacitive element; and wherein the active matrix type module further comprises a reverse polarity pulse supplying portion that supplies a reverse polarity pulse, which has reverse polarity to the scan pulse and is generated by logically inverting a phase of the scan pulse, to the capacitive element or the second transistor via a power supply line connected to a source electrode of the second transistor based on a timing that ensures simultaneity with an ON/OFF timing of the scan pulse.

In order to achieve the above-mentioned object, according to the invention of Claim 12, there is provided a driving method of an active matrix type module having a large number of capacitive memory cells disposed at crossing positions of the scan line and a data line disposed in a matrix, the capacitive memory cell including a first transistor that has a gate electrode connected to the scan line, and a source electrode connected to the data line, and a capacitive element that has a first terminal on one side connected to a drain electrode of the first transistor and that, when a scan pulse is supplied to the gate electrode from the scan line, accumulates a charge corresponding to a data voltage supplied from the data line via the source electrode and the drain electrode, the driving method comprising the steps of: a scan pulse supplying step for supplying the scan pulse to the gate electrode from the scan line; and a reverse polarity pulse supplying step for supplying a reverse polarity pulse, which has reverse polarity to the scan pulse and is generated by logically inverting a phase of the scan pulse, to the capacitive element via a second terminal of the other side of the capacitive element based on a timing that ensures simultaneity with an ON/OFF timing of the scan pulse.

### BRIEF DESCRIPTION OF THE DRAWINGS

FIG. 1 is a block diagram showing an example of the functions of a display device that employs the active matrix type display panel of the embodiment.

FIG. 2 is a diagram illustrating an example of the circuit of the pixel portion of the display panel.

FIG. 3 is a schematic diagram illustrating an example of the layered structure of a general organic thin film transistor formed by a wet process.

FIG. 4 is a time chart showing the relationship between the supply timings of the scan pulse supplied to the scan line of the display panel and the correction pulse supplied to the signal line corresponding to the scan line, and the gate voltage of the drive transistor.

FIG. 5 is a diagram illustrating an example of the circuit of the pixel portion of a comparison example.

FIG. 6 is a time chart showing the relationship between the supply timing of the scan pulse supplied to the scan line of the display panel provided with the pixel portion of the comparison example, and the gate voltage of the drive transistor.

FIG. 7 is a time chart showing the relationship between the supply timings of the scan pulse supplied to the scan line of the display panel and the correction pulse supplied to the signal line corresponding to the scan line, and the gate voltage of the drive transistor, with the ON/OFF timing of the scan pulse and correction pulse somewhat shifted.

FIG. 8 is a diagram illustrating an example of the circuit of the pixel portion of the display panel in a modification in which a correction pulse is supplied to the capacitor from the power supply line.

FIG. 9 is a diagram illustrating an example of the circuit of the pixel portion of the display panel in a modification in which a correction pulse is supplied to the drive transistor from the power supply line.

FIG. 10 is a diagram illustrating an example of the circuit of the pixel portion upon application to the memory element, electronic paper, and LCD active matrix type display panel.

### DETAILED DESCRIPTION OF PREFERRED EMBODIMENTS

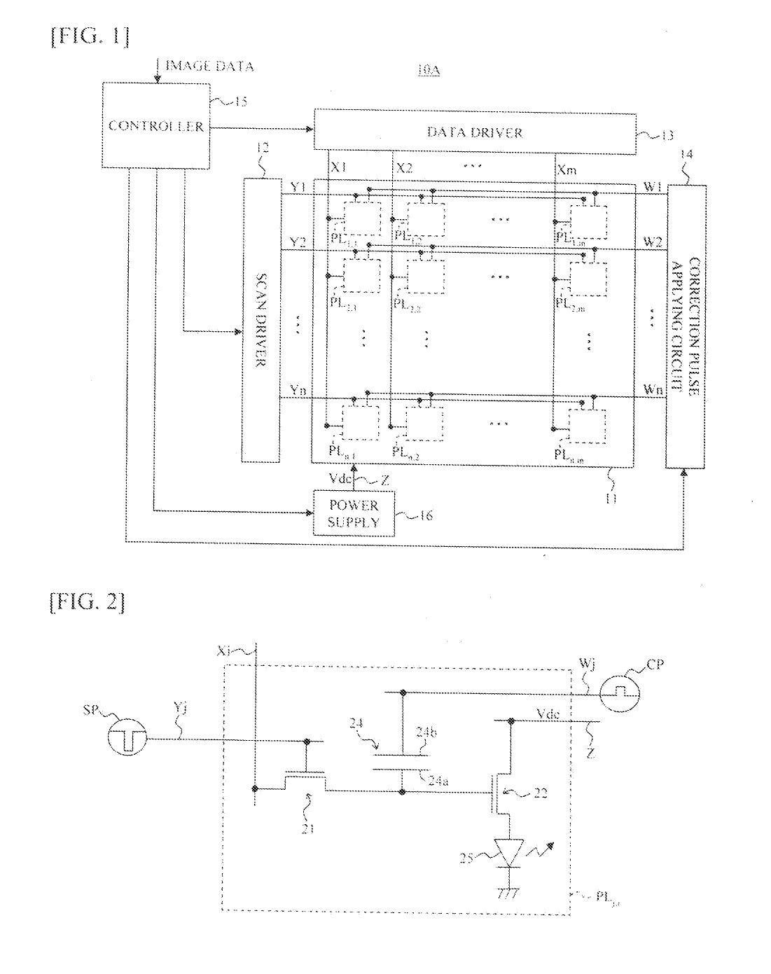

FIG. 1 is a block diagram showing an example of the functions of a display device 10A that employs an active matrix type display panel 11 (hereinafter “display panel 11”) as an active matrix type module of the embodiment. This display device 10A comprises the display panel 11, a scan driver 12, a data driver 13, a correction pulse applying circuit 14, a controller 15, and a light emitter driving power supply 16 (hereinafter, simply “power supply 16”).

The display panel 11 is an active matrix type comprising an m×n (where m and n are integers greater than 2) pixel portion, comprising a plurality of data lines X1 to Xm (Xi: i=1 to m), a plurality of scan lines Y1 to Yn (Yj: j=1 to n), and a plurality of pixel portions PL_{1,1} to PL_{n,m}, respectively disposed in parallel. The pixel portions PL_{1,1} to PL_{n,m} (capacitive memory cells) are disposed at crossing positions of the data lines X1 to Xm and the scan lines Y1 to Yn disposed in a matrix, each comprising the same configuration. Further, the pixel portions PL_{1,1} to PL_{n,m} are connected to a power supply line Z. A drive voltage (positive voltage Vdc) is supplied from the power supply 16 to the power supply line Z.

Furthermore, signal lines W1 to Wn respectively corresponding to scan lines Y1 to Yn are provided. These signal lines W1 to Wn are provided in the same quantity as and parallel to the scan lines, achieving a one-to-one correspondence with the scan lines Y1 to Yn. While details will be described later, a correction pulse CP of a predetermined size is supplied at a predetermined timing for each signal line from the correction pulse applying circuit 14 to the signal lines W1 to Wn. Note that the correction pulse applying circuit 14 and the signal lines W1 to Wn constitute the correction pulse supplying portion in the claims.

FIG. 2 is a diagram illustrating an example of the circuit of the pixel portion PL_{j,i} corresponding to the data line Xi (i=1, 2, . . . , m) and scan line Yj (j=1, 2, . . . , n) of the plurality of pixel portions of the display panel 11. The pixel portion PL_{j,i} comprises a scan transistor 21 (first transistor) and a drive transistor 22 (second transistor), a capacitor 24 (capacitive element), and a light emitter 25. The light emitter 25 employed may be, for example, an organic EL (electroluminescent) element. Further, the transistors 21 and 22 employed may be, for example, P-channel organic thin film transistors. Note that the light emitter and transistors are not limited to organic material; amorphous silicon and other semiconductor based light emitters as well as bipolar and other transistors may be used.

The gate electrode of the scan transistor 21 is connected to the scan line Yj (j=1 to n), and the source electrode is connected to the data line Xi (i=1 to m). Further, the drain connector of the scan transistor 21 is connected to the gate electrode of the drive transistor 22. The source electrode of the drive transistor 22 is connected to the power supply line Z, and the drive voltage Vdc is supplied from the power supply 16. Further, the gate electrode of the drive transistor 22 is connected to the drain electrode of the scan transistor 21, and to a first terminal 24a on one side of the capacitor 24. Further, the drain electrode of the drive transistor 22 is connected to the anode of the light emitter 25. The cathode of the light emitter 25 is then grounded.

The first terminal 24a of the capacitor 24 is connected to the drain electrode of the scan transistor 21, and a second terminal 24b on the other side is connected to the signal line Wj (j=1 to n). When a scan pulse SP is supplied to the gate electrode of the scan transistor 21 from the scan line Yj (j=1 to n), this capacitor 24 accumulates a charge corresponding to the data voltage supplied via the drain electrode and source electrode of the scan transistor 21 from the data line Xi (i=1 to m).

The correction pulse applying circuit 14, based on the control of a controller 15, supplies the correction pulse CP having reverse polarity to the scan pulse SP to the pixel portion PL_{j,i}, that is, the capacitor 24, based on timing corresponding to the supply timing of the scan pulse SP. Next, the method for calculating the amplitude of this correction pulse CP will be described.

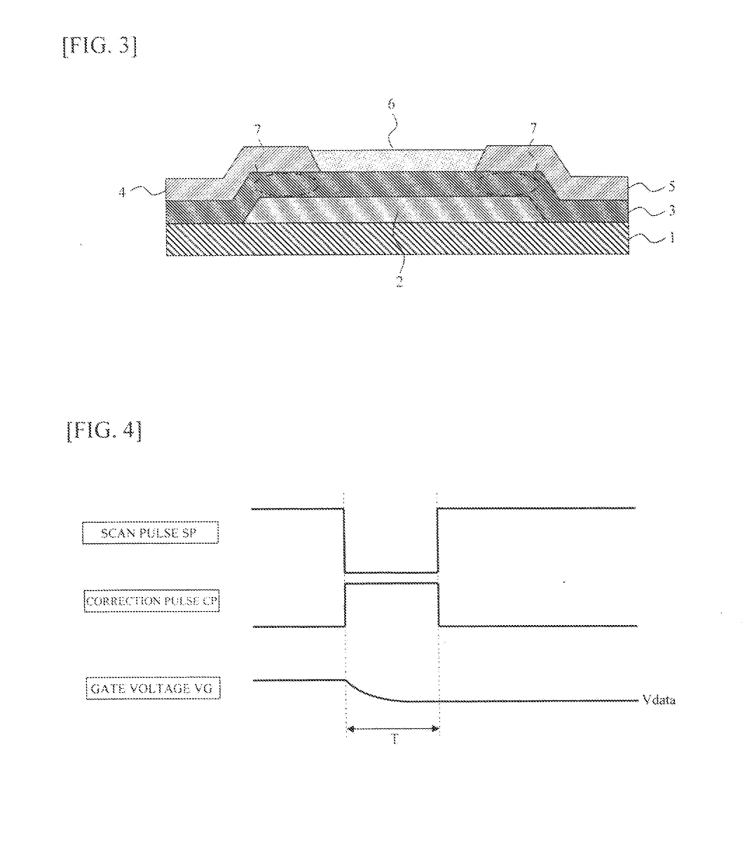

FIG. 3 is a schematic diagram illustrating an example of the layered structure of a general organic thin film transistor formed by a wet process, such as printing. This organic thin film transistor is formed in layers on top of a substrate 1, such as glass, in the order of a gate electrode 2, a gate insulating film 3, a source electrode 4 and a drain electrode 5, and an organic semiconductor 6 (organic semiconductor layer). Thus, with the gate electrode 2 and the channel electrodes 4 and 5 overlapping in the layered direction via the gate insulating film 3, the overlapping section forms capacitance, and a capacitive parasitic element 7 is formed between the gate and source electrodes and gate and drain electrodes of the transistors. The scan transistor 21 and the drive transistor 22 of this embodiment have the same configuration as described above. Thus, when the scan pulse SP is supplied to the scan transistor 21 with this parasitic element formed, feed-through occurs, resulting in extraction of the charge accumulated in the capacity 24 during the pulse OFF moment.

Here, given an amplitude V_{CP} of the correction pulse CP, an amplitude V_{SP} of the scan pulse SP, a capacitance CS of the capacitor 24, a total sum of all capacitance C_{ALL} as viewed from the gate line of the drive transistor 22, and a parasitic capacitance C_{SCAN} between the gate electrode and channel electrode of the scan transistor 21, a feed-through voltage ΔV1 that occurs at the moment the scan transistor 21 turns OFF is expressed by the following:

ΔV1=V_{SP}×C_{SCAN}/(C_{ALL}−C_{SCAN}) (1)

Further, a feed-through voltage ΔV2 produced by the OFF state of the correction pulse CP based on this same timing is expressed as follows:

ΔV2=V_{CP}×CS/(C_{ALL}−CS) (2)

Since the feed-through is offset if the sum of ΔV1 and ΔV2 is 0, then:

ΔV1+ΔV2=0 (3)

Based on the above equations (1) to (3):

V_{CP}=V_{SP}×[C_{SPAN} (C_{ALL}−CS)]/[CS (C_{ALL}−C_{SCAN})]

Here, given:

[C_{SCAN} (C_{ALL}−CS)]/[CS (C_{ALL}−C_{SCAN})]=k, then the following expression is achieved:

V_{CP}=−k×V_{SP} (k: Coefficient)

The coefficient k is controlled by the controller 15 (pulse amplitude adjusting unit), based on input from external input unit (not shown). That is, the display panel 11 is configured so that the amplitude V_{CP} of the correction pulse CP is adjustable from an external source.

Next, the relationship between the scan pulse SP and correction pulse CP supply timings will be described. FIG. 4 is a time chart showing the relationship between the supply timings of the scan pulse SP supplied to the scan line Yj of the display panel 11 and the correction pulse CP supplied to the signal line Wj corresponding to the scan line Yj, and the gate voltage Vg of the drive transistor 22.

According to this embodiment, the controller 15 logically inverts the phase of the scan pulse SP, generating the correction pulse CP having reverse polarity to the scan pulse SP. Then, the correction pulse applying circuit 14, based on the control of the controller 15, supplies the correction pulse CP to the signal line Wj so that the ON/OFF timing of the correction pulse CP is substantially the same as the ON/OFF timing of the scan pulse SP. With this arrangement, as shown in FIG. 4, the gate voltage Vg converges to data voltage Vdata at a data write interval T, making it possible not to receive any impact from the above feed-through effect. The following describes this in detail using a comparison example.

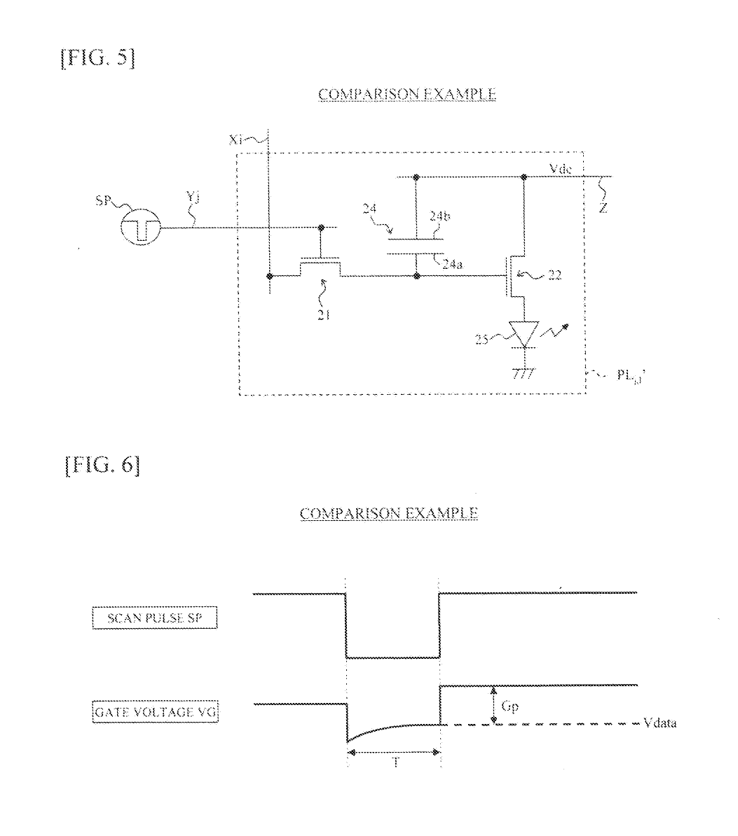

FIG. 5 is a diagram illustrating an example of the circuit of a pixel portion PL_{j,i}′ as a comparison example. The circuit of this pixel portion PL_{j,i}′ differs from that of PL_{j,i} of the embodiment in that the signal lines W1 to Wn that supply the correction pulse CP are not provided, and the second terminal 24b of the capacitor 24 is connected to the power supply line Z. With this arrangement, the drive voltage Vdc is supplied from the power supply 16 and the drain electrode of the drive transistor 22 to the second terminal 24b of the capacitor 24. All other components are the same as those of PL_{j,i}.

FIG. 6 is a time chart showing the relationship between the supply timing of the scan pulse SP supplied to the scan line Yj of the display panel 11 comprising the pixel portion PL_{j,i}′ of the comparison example, and the gate voltage Vg of the drive transistor 22.

In FIG. 6, when the scan pulse SP from the scan driver 12 is supplied to the scan line Yj to select the scan line Yj, the scan transistor 21 conducts electricity and a data pulse DP (data voltage Vdata) from the data driver 13 is supplied to the gate electrode of the drive transistor 22 via the scan transistor 21. At this time, the voltage Vdc is supplied to the second terminal 24b of the capacitor 24, causing a charge corresponding to the voltage Vdc−Vdata to accumulate in the capacitor 24 during the data write interval T shown in FIG. 6, and the voltage (hereinafter “held voltage”) corresponding to that charge to be held. With this arrangement, the gate voltage Vg converges to the data voltage Vdata. However, according to this comparison example, when the scan pulse SP changes to OFF, the charge accumulated in the capacitor 24 is extracted due to the feed-through effect based on the parasitic capacitance formed between the gate and drain electrodes of the scan transistor 21 during the pulse OFF moment, resulting in an error Gp in the data voltage Vdata.

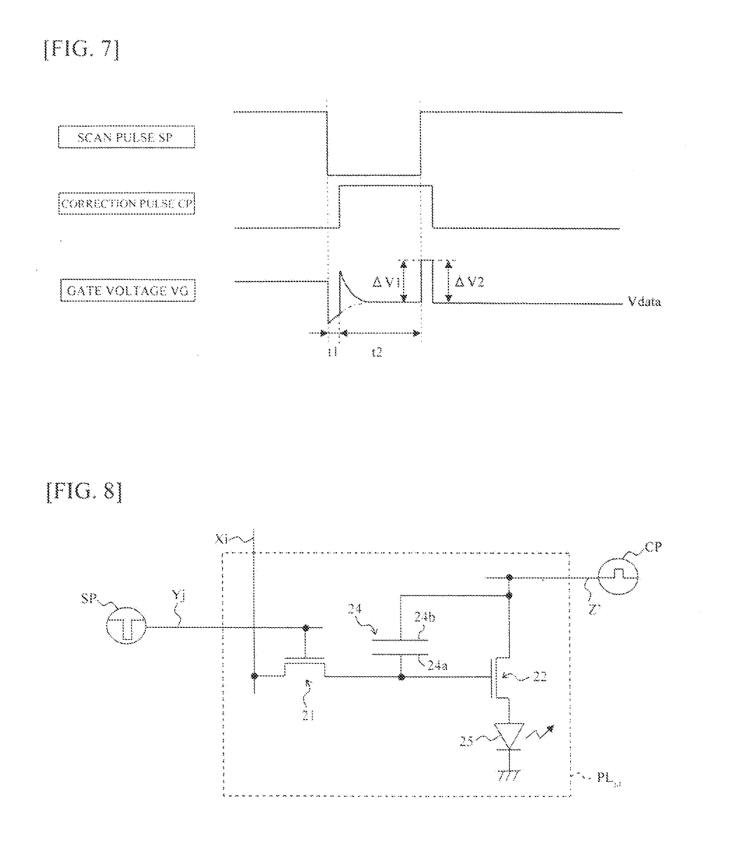

Here, according to this embodiment, the correction pulse CP having reverse polarity to the scan pulse SP as described above is supplied to the signal line Wj to achieve simultaneity with the ON/OFF timing of the scan pulse SP. The following describes the resulting correction effect on the error GP of the data voltage Vdata using FIG. 7.

FIG. 7 is a time chart showing the relationship between the supply timings of the scan pulse SP and the correction pulse CP, and the gate voltage Vg of the drive transistor 22. While the diagram corresponds to FIG. 4, here the ON/OFF timings of the scan pulse SP and the correction pulse CP are somewhat shifted to show the change in the gate voltage Vg.

In FIG. 7, based on the control of the controller 16, when the scan pulse SP from the scan driver 12 is supplied to the scan line Yj, the scan transistor 21 conducts electricity and the data pulse DP (data voltage Vdata) from the data driver 13 is supplied to the gate electrode of the drive transistor 22 via the scan transistor 21. With this arrangement, the gate voltage Vg changes in the negative direction and a charge corresponding to the voltage Vdc−Vdata is accumulated in the capacitor 24, causing the gate voltage Vg to converge to Vdata (interval t1). Next, based on the control of the controller 16, when the correction pulse CP from the correction pulse applying circuit 14 is supplied to the signal line Wj of the pixel portion PL_{j,i}, the gate voltage Vg changes in the positive direction. At this time, the correction voltage V_{CP} caused by the correction pulse CP is supplied to the second terminal 24b of the capacitor 24, causing the data voltage Vdata to be supplied to the first terminal 24a. As a result, a charge corresponding to the voltage V_{CP}−Vdata is accumulated in the capacitor 24. With this arrangement, the gate voltage Vg converges to the Vdata (interval t2).

Then, when the scan pulse SP turns OFF, the charge accumulated in the capacitor 24 is extracted due to the feed-through effect based on the parasitic capacitance formed between the gate and drain electrodes of the scan transistor 21 during the pulse OFF moment, and the gate voltage Vg changes in the positive direction by only an amount equivalent to the feed-through voltage ΔV1. Subsequently, when the correction pulse CP turns OFF, the charge is replenished in the capacitor 24 by the feed-through effect caused by pulse OFF, and the gate voltage Vg changes in the negative direction by only an amount equivalent to the feed-through voltage ΔV2 produced by the OFF state of the correction pulse CP. As described above, since the amplitude V_{CP} of the correction pulse CP is set so that sum of the feed-through voltage ΔV1 and the feed-through voltage ΔV2 is 0, the feed-though is offset and the gate voltage Vg changes to Vdata. When the correction pulse CP is supplied to achieve simultaneity with the ON/OFF timing of the scan pulse SP as a result of correcting the data voltage by the correction pulse CP as described above, the time chart changes to that shown in FIG. 4.

Note that, simultaneity between the ON/OFF timing of the correction pulse CP and the ON/OFF timing of the scan pulse SP is not necessarily required as in this embodiment, allowing the correction pulse to actually be supplied at a timing shifted from that of the scan pulse SP as shown in FIG. 7. However, in such a case, if the ON timing of the correction pulse CP is significantly delayed further than the SP ON timing, the data write time (equivalent to the interval t2) becomes difficult to maintain, requiring the ON timing delay to fall within a range in which the write time can be maintained. Further, in a case where the OFF timing of the correction pulse CP is ahead of the OFF timing of the scan pulse SP, fluctuation in data voltage will occur due to feed-through after correction, requiring the OFF timing of the correction pulse CP to fall after the OFF timing of the scan pulse SP. Furthermore, in such a case, if the OFF timing of the correction pulse CP is delayed further than the OFF timing of SP, data voltage with an error occurs during that period; thus it is preferable to keep the delay of the OFF timing as small as possible.

Further, in the above, the step wherein the controller 15 controls the scan driver 12 so that the scan pulse SP is supplied to the gate electrode of the scan transistor 21 via the scan line Yj is equivalent to the scan pulse supplying step in the claims, and the step in which the controller 15 controls the correction pulse applying circuit 14 so that the correction pulse CP is supplied to the capacitor 24 via the signal line Wj is equivalent to the correction pulse supplying step.

According to the embodiment described above, the following advantages are achieved. That is, the display panel 11 of this embodiment comprises a large number of pixel portions PL_{j,i} at the crossing positions of the scan line Yj and the data line Xi disposed in a matrix, with each pixel portion PL_{j,i} comprising the scan transistor 21 and the capacitor 24. Electricity is conducted between the source and drain electrodes of the scan transistor 21 when a scan pulse SP is supplied to the gate electrode of the scan transistor 21 from the scan line Yj. With this arrangement, data voltage is supplied from the data line Xi via the source and drain electrodes of the scan transistor 21, causing an electric charge corresponding to the data voltage to accumulate in the capacitor 24. At this time, the correction pulse applying circuit 14 supplies the correction pulse CP, which has reverse polarity to the scan pulse SP, to the capacitor 24 of each of the pixel portions PL_{j,i} via the signal line Wj at a timing corresponding to the supply timing of the scan pulse SP. With this arrangement, the charge is replenished to the capacitor 24, making it possible to suppress any decrease in charge of the capacitor 24 caused by the feed-through effect. As a result, it is possible to correct the error in the data voltage caused by the feed-through effect without increasing the number of transistors of each of the pixel portions PL_{j,i}. Accordingly, it is possible to prevent a decrease in yield of the display panel 11 and a decrease in the aperture ratio.

In the display panel 11 of the embodiment, in addition to the above configuration, the pixel portion PL_{j,i} further comprises the drive transistor 22. That is, the data voltage accumulated in the capacitor 24 from the scan pulse SP supplied to the gate electrode of the scan transistor 21 from the scan line Yj is supplied between the gate and source electrodes of the drive transistor 22, and the drain current corresponding to the data voltage is introduced between the drain and source electrodes of the drive transistor 22 and supplied to the light emitter 25. With such a two-transistor configuration, it is possible to achieve the display panel 11 capable of correcting the error of the data voltage caused by the feed-through effect and preventing a decrease in yield and a decrease in aperture ratio.

In the display panel 11 of the embodiment, in addition to the above configuration, the capacitor 24 further comprises the second terminal 24b in addition to the first terminal 24a connected to the drain electrode of the scan transistor 21, and the correction pulse applying circuit 14 supplies the correction pulse CP to the capacitor 24 via the signal line Wj and the second terminal 24b. With this arrangement, charge is directly replenished to the capacitor 24, making it possible to reliably suppress any decrease in the charge of the capacitor 24 caused by the feed-through effect.

In the display panel 11 of the embodiment, in addition to the configuration above, the display panel 11 further comprises the signal line Wj provided in a same quantity as the scan line Yj so that each is respectively connected to the second terminal 24b of the capacitor 24 related to the plurality of pixel portions PL_{j,I} disposed along the scan line Yj, is arranged substantially in parallel with the scan line Yj, and forms one-to-one correspondence with the scan line Yj. Then, the correction pulse CP is supplied from this signal line Wj to the capacitor 24 via the second terminal 24b. With this arrangement, it is possible to supply the correction pulse CP independently from the power supply system of the drive transistor 22.

In the display panel 11 of the embodiment, in addition to the configuration above, the correction pulse applying circuit 14 supplies the correction pulse CP to the capacitor 24 so that the OFF timing of the correction pulse CP is after the OFF timing of the scan pulse SP. That is, in a case where the OFF timing of the correction pulse CP is prior to the OFF timing of the scan pulse SP, the scan pulse SP turns OFF after the correction pulse ends and an error occurs in the data voltage due to the feed-through effect when the pulse is OFF, causing the OFF timing of the correction pulse CP to occur at the same time or after the OFF timing of the scan pulse SP, making it possible to reliably correct the error in the data voltage caused by the feed-through effect in the same manner as in the embodiment.

In the display panel 11 of the embodiment, in addition to the above configuration, the correction pulse CP is generated by logically inverting the phase of the scan pulse SP, and the correction pulse applying circuit 14 supplies the correction pulse CP to the capacitor 24 so that the ON/OFF timing of the correction pulse CP is substantially the same as the ON/OFF timing of the scan pulse SP. With this arrangement, both the scan pulse SP and the correction pulse CP are acceptable as long as they are processed and generated based on the same logic signal, resulting in rationality. Further, the charge time of the capacitor 24 after scan pulse ON can be sufficiently maintained since the ON timing of the correction pulse CP and the ON timing of the scan pulse SP are the same, and the error in data voltage caused by the feed-through effect can be reliably corrected as described above since the OFF timing of the correction pulse CP and the OFF timing of the scan pulse SP are the same.

In the display panel 11 of the embodiment, in addition to the above configuration, the pulse amplitude of the correction pulse CP is adjustable by the controller 15. With this arrangement, the pulse amplitude of the correction pulse CP can be adjusted to a suitable value from outside the display panel 11, and the error in data voltage caused by the feed-through effect can be reliably corrected.

In the display panel 11 of the embodiment, in addition to the above configuration, the gate electrode, source electrode, and drain electrode of the scan transistor 21 and the drive transistor 22 are formed by a wet process such as printing. With this arrangement, it is possible to manufacture an active matrix type module with a large surface area more conveniently and inexpensively than a case where a dry process is used. Further, in a case where a transistor is manufactured by a printing process, in particular, it is difficult to ensure that the gate electrode and channel electrode do not overlap in the layered direction via the gate insulating film, resulting in a feed-through effect due to the parasitic element. Accordingly, such a process is preferred as an applicable target of the configuration of the embodiment, which achieves reduction of the feed-through effect.

In the display panel 11 of the embodiment, in addition to the above configuration, an organic thin film transistor having the organic semiconductor 6 is used as the scan transistor 21 and the drive transistor 22. With this arrangement, it is possible to more softly form the transistor compared to a case with a silicon semiconductor, making manufacture based on a low-temperature process possible. Further, since formation based on a printing process is possible, an active matrix type module having a large surface area can be inexpensively created.

Note that various modifications may be made according to the present embodiment without departing from the spirit and scope of the invention, in addition to the above-described embodiment. In the following, details of such modifications will be described one by one.
(1) When Supplying the Correction Pulse From the Power Supply Line to the Capacitor

While, according to the embodiment, the signal line Wj for correction pulse supply is provided and the correction pulse CP is supplied to the capacitor 24 via the signal line Wj, the present invention is not limited thereto, allowing the correction pulse CP to be supplied via the power supply line Z that supplies the drive voltage to the drive transistor 22.

FIG. 8 is a diagram illustrating an example of the circuit of the pixel portion PL_{j,i} of the modification. As shown in FIG. 8, the source electrode of the drive transistor 22 and the second terminal 24b of the capacitor 24 are connected to a power supply line Z′. Then, the correction pulse applying circuit 14 supplies the correction pulse CP to the capacitor 24 via the power supply line Z′. Note that, according to this modification, the power supply 16 is not required. With this arrangement, the charge is replenished to the capacitor 24, making it possible to suppress any decrease in charge of the capacitor 24 caused by the feed-through effect. Further, the configuration is designed so that the correction pulse CP is thus supplied using the power supply line Z′ of the drive transistor 22, making a new signal line for correction pulse supply no longer necessary and minimizing the number of wires in the same manner as the embodiment. Furthermore, compared to a case where the correction pulse CP is supplied from a dedicated signal line to the capacitor 24, the advantage of reducing the amplitude V_{CP} of the correction pulse CP is also achieved.
(2) When Supplying the Correction Pulse From the Power Supply Line to the Drive Transistor

While, according to modification (1), the correction pulse CP is supplied from the power supply line Z′ to the capacitor 24, the present invention is not limited thereto, allowing supply of the correction pulse CP from the power supply line Z′ to the drive transistor 22.

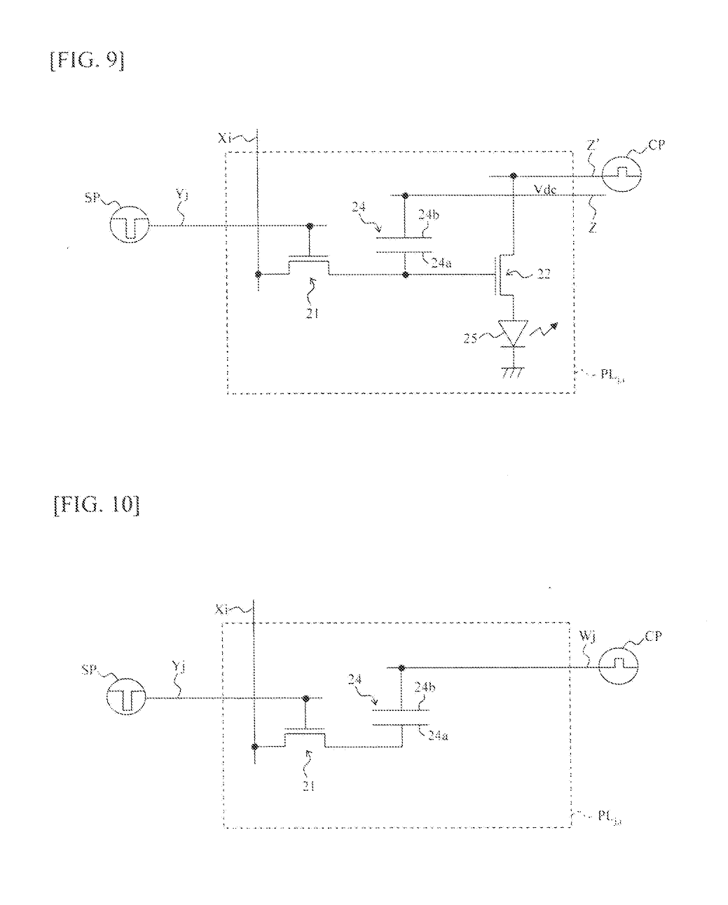

FIG. 9 is a diagram illustrating an example of the circuit of the pixel portion PL_{j,i} of the modification. As shown in FIG. 9, the source electrode of the drive transistor 22 is connected to the power supply line Z′. Further, the second terminal 24b of the capacitor 24 is connected to the power supply line Z where the power supply voltage (positive voltage Vdc) is supplied from the power supply 16. Then, according to this modification, the correction pulse applying circuit 14 supplies the correction pulse CP to the drive transistor 22 via the power supply line Z′. With this arrangement, it is possible to supply the correction pulse CP to the parasitic capacitance formed between the gate and source electrodes of the drive transistor 22. As a result, the charge is replenished to the parasitic capacitance, making it possible to suppress any decrease in charge of the capacitor 24 caused by the feed-through effect.

Note that, in the modifications (1) and (2), consideration of the following is required. That is, since the supply line of the correction pulse CP is provided parallel to and in the same quantity as the scan line Yj, the power supply line Z′ is provided in the same quantity as the scan line Yj when the power supply line Z′ is the supply line of the correction pulse CP, as in the modifications (1) and (2). At this time, in the case of a full color panel, for example, at least the pixel portions PL_{j,i} of three colors are generally disposed on the same scan line. As a result, in a case where the power supply line Z′ is the supply line of the correction pulse CP, a plan wherein the power supply line Z′ of the drive transistor 22 is commonly driven for each color is required.

(3) When Applying the Present Invention to a Module Other Than a Display Panel

While the embodiment describes an active matrix type display panel that uses an organic EL as an example of the active matrix type module, the present invention is not limited thereto, allowing application to an LCD active matrix type display panel that uses liquid crystal, for example. Further, the module is not limited to a display panel, allowing application to other modules as long as the module has a large number of high density capacitive memory cells, such as imaging elements, electronic paper, or memory elements.

FIG. 10 is a diagram illustrating an example of the circuit of the pixel portion PL_{j,i} upon application to the memory element, electronic paper, and LCD active matrix type display panel. As shown in FIG. 10, the pixel portion PL_{j,i} of this modification comprises a single scan transistor 21 (first transistor) and the capacitor 24 (capacitive element). The second terminal 24b of the capacitor 24 is connected to the signal line Wj (j=1 to n). Then, similar to the embodiment, the correction pulse applying circuit 14, based on the control of the controller 15, supplies the correction pulse CP, which has reverse polarity to the scan pulse SP, to the capacitor 24 via the signal line Wj and the second terminal 24b based on a timing corresponding to the supply timing of the scan pulse SP. With this arrangement, it is possible to achieve the same advantages as those of the embodiment.
(4) Other

While the embodiment describes an illustrative scenario of a display panel having the pixel portion PL_{j,i} comprising the transistors 21 and 22 formed by a wet process, the present invention is not limited thereto, and is effective with modules comprising a transistor formed by a silicon process capable of higher precision processing than the wet process. That is, even in a case where the transistors are formed by a silicon process, the parasitic capacitance effect increases when the pixel portion PL_{j,i} is reduced and the transistor size is thinned, sometimes resulting in input difficulties even with two direct signals, such as “Hi” and “Lo.” Applying the present invention to such a module makes it possible to offset the impact of the parasitic capacitance, enabling less strict transistor design specifications, higher display definition, higher memory density, and an improved panel yield.

1-12. (canceled)

13. An active matrix type module comprising:
a large number of capacitive memory cells disposed at crossing positions of a scan line and a data line disposed in a matrix,
said capacitive memory cell including:
a first transistor that has a gate electrode connected to said scan line, and a source electrode connected to said data line; and
a capacitive element that, when a first terminal on one side is connected to a drain electrode of said first transistor and a scan pulse is supplied to said gate electrode from said scan line, accumulates a charge corresponding to a data voltage supplied from said data line via said source electrode and said drain electrode; and
a capacitive element that has a first terminal on one side connected to a drain electrode of said first transistor and that, when a scan pulse is supplied to said gate electrode from said scan line, accumulates a charge corresponding to a data voltage supplied from said data line via said source electrode and said drain electrode; and wherein
said active matrix type module further comprises
a reverse polarity pulse supplying portion that supplies a reverse polarity pulse, which has reverse polarity to said scan pulse and is generated by logically inverting a phase of said scan pulse, to said capacitive element via a second terminal of the other side of said capacitive element based on a timing that ensures simultaneity with an ON/OFF timing of said scan pulse.

14. The active matrix type module according to claim 13, wherein:
said capacitive memory cell further includes:
a second transistor that comprises a gate electrode that is connected to the drain electrode of said first transistor, and to said first terminal of said capacitive element; and
a light emitter that an anode is connected to a drain electrode of said second transistor.

15. The active matrix type module according to claim 14, wherein:
said reverse polarity pulse supplying portion further comprises:
at least a signal line that is connected to said second terminal of said capacitive element related to a plurality of said capacitive memory cells disposed along said scan line, is disposed substantially parallel with said scan line, and is provided in a same quantity as said scan line so as to form one-to-one correspondence with said scan line.

16. An active matrix type module comprising:
a large number of capacitive memory cells disposed at crossing positions of a scan line and a data line disposed in a matrix,
said capacitive memory cell including:
a first transistor that has a gate electrode connected to said scan line, and a source electrode connected to said data line;
a capacitive element that has a first terminal on one side connected to a drain electrode of said first transistor and that, when a scan pulse is supplied to said gate electrode from said scan line, accumulates a charge corresponding to a data voltage supplied from said data line via said source electrode and said drain electrode; and
a second transistor that has a gate electrode connected to a drain electrode of said first transistor and said first terminal of said capacitive element; and wherein
said active matrix type module further comprises
a reverse polarity pulse supplying portion that supplies a reverse polarity pulse, which has reverse polarity to said scan pulse and is generated by logically inverting a phase of said scan pulse, to said capacitive element or said second transistor via a power supply line connected to a source electrode of said second transistor based on a timing that ensures simultaneity with an ON/OFF timing of said scan pulse.

17. The active matrix type module according to claim 13, further comprising:
a pulse amplitude adjusting unit capable of adjusting an amplitude of said reverse polarity pulse.

18. The active matrix type module according to claim 14, wherein:
said gate electrode, said source electrode, and said drain electrode of said first transistor and said second transistor are formed by a wet process.

19. The active matrix type module according to claim 18, wherein:
said first transistor and said second transistor are organic thin film transistors each having an organic semiconductor layer.

20. The active matrix type module according to claim 13, wherein:
said active matrix type module is an active matrix type display panel.

21. A driving method of an active matrix type module having a large number of capacitive memory cells disposed at crossing positions of said scan line and a data line disposed in a matrix, said capacitive memory cell including a first transistor that has a gate electrode connected to a scan line, and a source electrode connected to said data line, and a capacitive element that has a first terminal on one side connected to a drain electrode of said first transistor and that, when a scan pulse is supplied to said gate electrode from said scan line, accumulates a charge corresponding to a data voltage supplied from said data line via said source electrode and said drain electrode, the driving method comprising the steps of:
a scan pulse supplying step for supplying said scan pulse to said gate electrode from said scan line; and
a reverse polarity pulse supplying step for supplying a reverse polarity pulse, which has reverse polarity to said scan pulse and is generated by logically inverting a phase of said scan pulse, to said capacitive element via a second terminal of the other side of said capacitive element based on a timing that ensures simultaneity with an ON/OFF timing of said scan pulse.
